(19) United States
(12) Patent Application Publication
(10) Pub. No.: US 2007/0089951 A1
(43) Pub. Date: Apr. 26, 2007

(54) Air spring protective sleeve

(76) Inventor: Peter Skiba, Riverside, CA (US)

Correspondence Address: LAW OFFICE OF J. CURTIS EDMONDSON, P.O. BOX 571, CLAREMONT, CA, 91711, US

(21) Appl. No.: 11/255,708

(22) Filed: Oct. 20, 2005

(51) Int. Cl. F16F 9/04

(52) U.S. Cl. 188/322.12; 267/64.27

(57) ABSTRACT

The present invention discloses a protective device for vehicular air springs. An air spring is typically consists of an exposed flexible bladder mounted between the axle and the frame of the vehicle. The exposed bladder is subject to penetration by flying debris. The protective device shields the exposed bladders from damage. The protective device is easy to install allowing vehicles with existing air springs to take advantage of the features of the protective device.

### BACKGROUND

1. Field of the Invention

This invention relates to protective device for air springs, in particular a non-contact protective sleeve that envelopes air springs and is easy to install on motor vehicles.

2. Description of the Related Art

Air springs are designed to provide the occupant of an automobile, truck, or other type of vehicle with a smoother ride. These springs are well known in the arts and act to reduce sharp forces caused by bumps or holes in the road. Air springs are also known in the trade as air bellows.

The OMA 95 FA Ride Rite™ Helper Springs marketed by the Firestone Corporation is a typical example of an air spring. An air spring typically consists of two sealed rubber disk like bladders. There is a valve at one end of the spring for air to be injected or removed from the bladders. The compressed air in these bladders provide the desired ‘cushion’ for the occupants in the vehicle.

The installation instructions provided with the Firestone Helper Springs are illustrative of how the springs are installed into the vehicle. An unpressurized spring is installed and then inflated under a vehicle load to an air pressure that is specified in the instructions. During movement of the vehicle, air delivery systems can also be installed on the vehicles to inflate or deflate the bladders for the purpose of changing the suspension characteristics of the air spring.

U.S. Pat. No. 5,265,907 to Tostado is illustrative of how an air spring is mounted to the frame of the automobile.

A sudden loss of pressure of an installed air spring will cause the vehicle to tilt to one side. While the vehicle is stationary this would have little effect, but, if this happens while the vehicle is moving, instability can result, leading to loss of control of the automobile.

Air springs are typically made from a flexible, rubber-like material. The material on the air springs is subject to puncture from sharp objects, such as flying pieces of metal. These pieces of metal are commonly found on the highway and are easily ‘kicked up’ by other automobiles. Therefore the rubber on the air spring may possibly be punctured while the vehicle is in motion, potentially leading to loss of stability in the moving vehicle.

Traditional gas shock pistons are well known in the arts. These pistons have metal casings and have different suspension characteristics than air springs.

U.S. Pat. No. 5,669,597 to Rittstieg, et al. depicts a self-pumping air suspension spring. This air suspension spring has an upper component section that is made of metal. One of the disadvantages of this device is that the integrated expansion bellows is not designed to protect the ring of flexible material directly below the metal shaft.

U.S. Pat. No. 5,480,129 to Gilsdorf, et al. describes an air spring with an integrated expansion bellows assembly. The expansion bellows is connected to the metal sleeve via a compression connection. The disadvantage of this design is that the expansion bellows makes contact with the sleeve and is not protected.

U.S. Pat. No. 4,722,516 to Gregg describes an air spring with a flexible membrane and a metal shroud that is comes into the contact with the flexible membrane. This disadvantage of this design is that the flexible membrane is an integrated assembly with the metal shroud and is in contact with the metal.

None of the aforementioned patents teach the use of protective sleeve for an air spring that does not come into contact with the expansion bellow and can be installed independently of the air spring.

It is an object of this invention to provide a protective shield for an air spring that is easy to install and durable.

It is another object of this invention to provide a protective shield for an air spring that is designed to minimize wind resistance while the vehicle is in motion.

It is another object of this invention to provide an easy way to install the protective sleeve on vehicles that do not have air springs and those that already have air springs installed.

It is another object of this invention to provide a protective shield for air springs that is designed to have minimal weight by using either lightweight materials or using existing materials with small holes.

It is another object of this invention to provide a protective shield for air springs to prevent the flexible material on the air bellows or air spring from accelerated degradation due to sun exposure.

It is another object of this invention to provide a protective shield that is attractive and supports ornamental designs on the surface of the protective shield.

### SUMMARY OF THE INVENTION

The present invention discloses a protective sleeve for vehicular air springs. An air spring consists of an exposed flexible bladder mounted between the axle and the frame of the vehicle. The exposed bladder is subject to penetration by flying debris leading to pressure loss. The sudden loss of pressure may cause vehicular instability.

The protective sleeve is easy to install allowing vehicles with existing air springs to take advantage of the features of the protective device.

### BRIEF DESCRIPTION OF THE DRAWINGS.

FIG. 1 is a front view of the protective sleeve assembly.

FIG. 2 is a sectional view of the protective sleeve assembly with a partial view into the interior components.

FIG. 3 is a top view of the upper half of the protective sleeve.

FIG. 4 is a top view of the lower half of the protective sleeve.

FIG. 5 is an installed view of the protective sleeve.

### DETAILED DESCRIPTION

While describing the invention and its embodiments various terms will be used for the sake of clarity. These terms are intended to not only include the recited embodiments, but also all equivalents that perform substantially the same function, in substantially the same manner to achieve the same result.

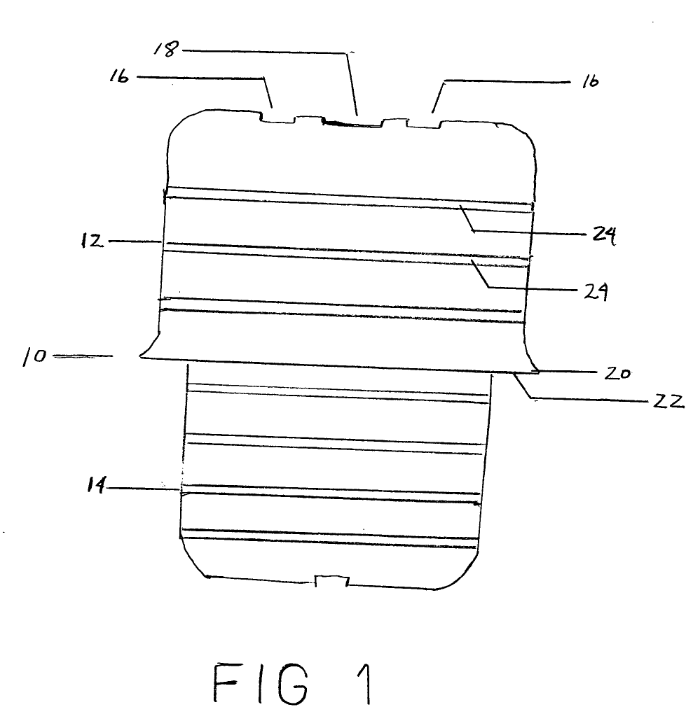

FIG. 1 provides a front view of a protective sleeve 10. The protective sleeve consists of two sections, an upper section 12 and a lower section 14. The upper section 12 consists of a number of assembly holes 16 for mounting the upper section 12 to a bracket on the frame of the car. The upper section 12 incorporates a hole 18 for the bladder inflation valve. The upper section 12 incorporates a flaring 20 of the metal towards the base 22 of the upper section 12. The upper section 12 can also incorporate ornamental designs on the surface of the upper section, in this case, a ribbed design 24.

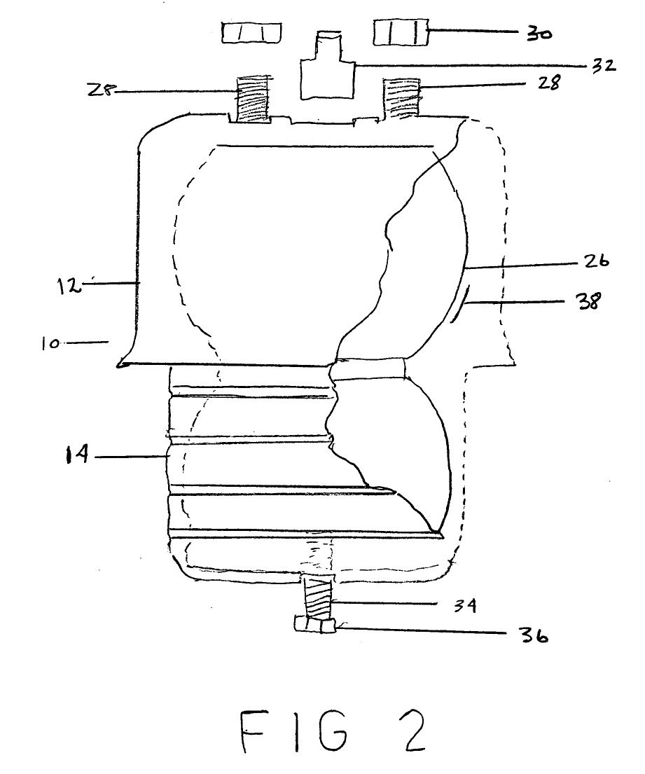

FIG. 2 provides a sectional view of the protective sleeve 10 to illustrate how the upper section 12 and lower section 14 are mounted over the air spring 26. The upper part of the air spring 26 consists of a number of mounting bolts 28 and nuts 30 for attaching the air spring 26 to the vehicle. The air spring 26 also has a bladder inflation valve 32. The lower part of the air spring 26 consists of the bolt 34 and nut 36 for attaching the air spring to the vehicle. The edge of the bladder of the air spring has a maximal radius 38 when the vehicle is in operation as indicated by the partial line.

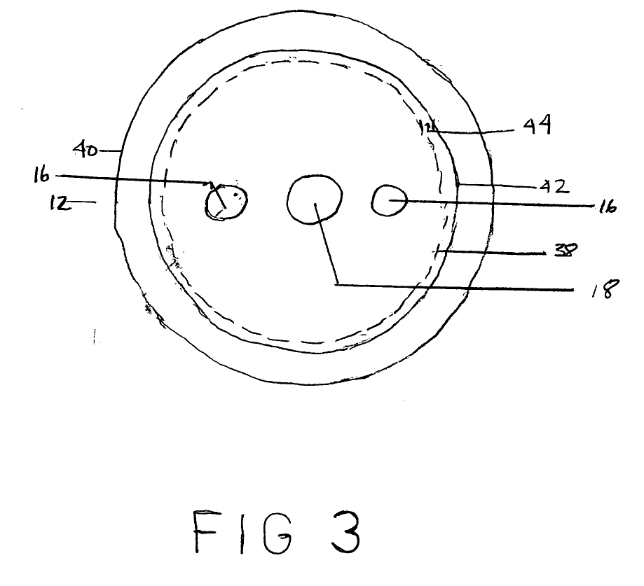

FIG. 3 provides a top view of the upper section 12 of the protective sleeve. The outer boundary of the base of the sleeve is 40 is flared out from main cylinder 42 of the upper section 12. The main cylinder 42 is dimensioned so that there is a space 44 between the maximal radius 38 of the bladder and the inner wall of the main cylinder 42. The top of the upper section has a number of assembly holes 16 dimensioned to allow a bolt connected to an air spring to pass through. The top of the upper section also has a hole 18 dimensioned to allow a bladder inflation valve 32 to pass through.

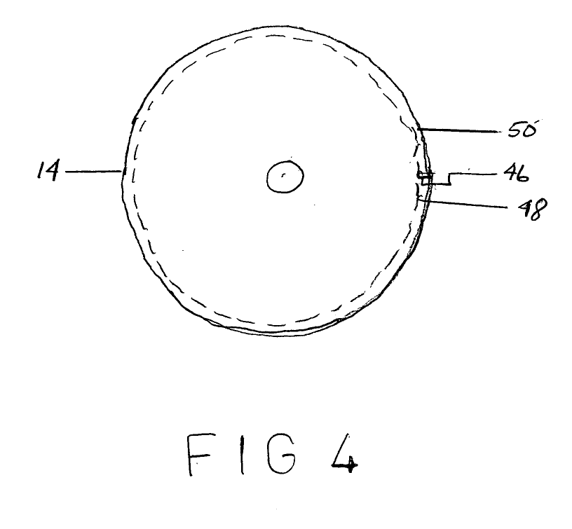

FIG. 4 provides a top view of the lower section 14 of the protective sleeve. The outer boundary of the top of the sleeve 14 is dimensioned so that there is a space 46 between the maximal radius 48 of the bladder and the inner wall 50 of the sleeve.

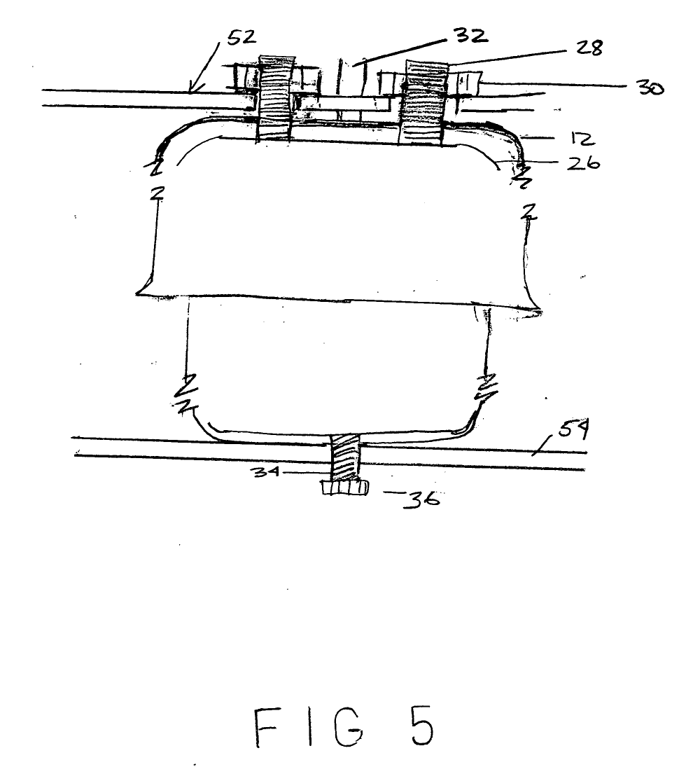

FIG. 5 shows the installation of the upper section 12 of the protective sleeve. The upper section 12 of the protective sleeve is placed against the upper frame 52 of the vehicle. The bolts 28 and the bladder inflation valve 32 are pushed up against the base of the upper section 12 of the protective shield. The nuts 30 are attached to the attached to the bolts 28 and tightened causing the upper section to press against the upper frame 52. The bottom section 14 of the air shock is placed over the bolt 34 at the base of the air spring 26. The bolt 34 is then inserted into the lower frame 54 of the vehicle. A nut 36 is then tightened on the lower 54 of the vehicle. The air spring is inflated via the bladder inflation valve 32.

With the protective sleeve installed over the air spring is protected against various road hazards and insults, while still allowing for the normal expansion and contraction of the air bladder. These insults can consist of flying metal, wood chips, gravel, and other debris that is present on the roadway. These insults can already be in motion having been ‘kicked up’ by the preceding vehicle.

Another feature of the protective sleeve is the ability to shield the flexible material of the bladder from exposure to the sun. Exposure of these parts to the sun causes accelerated degradation of the materials and hastens the eventual replacement.

The protective sleeve also provides protection to a person or the undercarriage of the vehicle if the air bladder should burst upon inflation or operation.

The protective sleeve can be made from any number of materials, including, but not limited to metal, plastic or composite materials. The materials should be strong enough to withstand an impact from flying debris, durable enough to withstand exposure to the elements for extended periods of time.

The protective sleeve is not required to be cylindrical. Other shapes, including box, hexagonal, elliptical, and other novel shapes may be employed. The design of the protective sleeve may be modified to reduce wind drag around the air bellow or air spring, thereby increasing vehicle efficiency.

The configuration of the protective sleeve does not have to be contiguous. It may be bifurcated in a hinged designed to aid in attachment to the air bellow or air spring. The design improves installation because an existing air spring does not have to removed to install the protective shield.

Likewise it is not necessary to have an upper protective sleeve and a lower protective sleeve. A configuration may include a single protective sleeve, either upper or lower, that extends beyond the midpoint of the air spring. In this configuration the protective sleeve assembly consists of a lesser number of parts.

Also, the protective sleeve may be made from materials that are not entirely solid, for example, a screen material with a density to prevent most particles from penetrating the sleeve.

Alternate methods of attaching the protective sleeve exist. For example, the sleeve may be clipped to the inner section of the air spring where the two bladders meet. Alternatively, the protective sleeve may be attached to other parts of the frame and axle not including the air spring mounting holes. This will aid in assembly since the air spring does not have to be removed before installation.

Because the protective sleeve may be visible from outside the vehicle, it is desirable to provide ornamentation to the exterior of the protective sleeve. This ornamentation can consist of any number of insignia's, logo's or designs. Alternatively, the ornamentation can consist of spinning designs similar to those found in automobile rims.

Although the protective sleeve has been described in conjunction with an air spring, it is understood that it may be used to protect other types of spring assembly structures.

It should be understood that various modifications within the scope of this invention can be made by one of ordinary skill in the art without departing form the spirit thereof. I therefore wish my invention to be defined by the scope of the appended claims as broadly as the prior art will permit, and in view of this specification if need be.

I claim:

1. An assembly comprising a protective sleeve and a mounted air spring,
wherein said mounted air spring is positioned between the frame and the axle of a vehicle,
wherein in use, the protective sleeve is adapted to protect the mounted air spring from insult when the air spring is mounted upon a vehicle via a coupling member,
the protective sleeve comprising an elongated plate having a first end and a second end, and shaped and sized so as to cover at least 75% of the area of said air spring when viewed from one view point.

2. A protective sleeve as in claim 1 where the inner surface of the elongated plate of the protective sleeve does not contact the air spring.

3. A protective sleeve as in claim 1 where the protective sleeve consists of an upper protective sleeve and a lower protective sleeve, with one sleeve positioned to overlay the other sleeve.

4. A protective sleeve as in claim 1 where the wall of the upper protective sleeve is configured to minimize wind resistance.

5. A protective sleeve as in claim 1 wherein the sleeve is split into two portions along the elongated portion of the plate; the two portions joined by a hinge.

6. A protective sleeve as in claim 1 wherein the protective sleeve is mounted on a part of the air spring via a coupling member.

7. A protective sleeve as in claim 1 wherein the protective sleeve is contiguous enough to protect the mounted air spring from sun degradation.

8. Method for installing a protective sleeve on an air spring whereby
the protective sleeve is placed in position on the frame of the vehicle and the air shock is inserted into the protective sleeve and attached to the frame and the axle of the vehicle, and the protective sleeve is coupled to a mounting point on the vehicle.
